(19) United States
(12) Patent Application Publication
(10) Pub. No.: US 2002/0068163 A1
(43) Pub. Date: Jun. 6, 2002

(54) Electrostatic pad

(76) Inventor: Rodrigue McDuff, Laval (CA)

Correspondence Address: SWABEY OGILVY RENAULT, Suite 1600, 1981 McGill Avenue, Montreal, QC, H3A 2Y3, CA

(21) Appl. No.: 09/730,491

(22) Filed: Dec. 6, 2000

(51) Int. Cl. B32B 3/26

(52) U.S. Cl. 428/314.8; 428/319.1; 428/319.9

(57) ABSTRACT

The pad according to the invention can adhere to a polished surface for an extended period of time. It comprises a core support layer made of foam plastic material, for example a copolymer of ethylene and vinyl acetate, and electrostatic layer, for example comprising a polypropylene base electrostatic film, on one face of the pad. The opposite face of the pad must be capable of receiving thereon information to be displayed. The foam plastic material is characterized by having a closed cell structure and a density between 1.5 and 4, and by being capable of retaining electrostatic charges between the core support layer and the electrostatic layer after being activated.

### BACKGROUND OF INVENTION

(a) Field of the Invention

This invention relates to a pad that is capable of adhering against a surface, such as a glass pane, a mirror, a dry wall or the like. More particularly, the invention is concerned with the choice of specific materials, including a core support layer and an electrostatic film, which are laminated together in such a manner that one material acts in retaining the electrostatic charges of the electrostatic material.

(b) Description of Prior Art

The use of an electrostatic material for various purposes is well known. For example, U.S. Pat. No. 5,219,168 describes a puzzle apparatus in which the puzzle pieces each comprise a layer of fibrous material provided with a design and a layer of magnetic material such as electrostatic vinyl to which the layer of fibrous material is affixed. It has been observed that this type of material rapidly looses its electrostatic charges if it is treated to regain its charges. The same holds true with respect to my U.S. application Ser. No. 09/248,893 filed Feb. 12, 1999 now abandoned.

U.S. Pat. No. 4,992,121 describes a method of electrostatic charging an electrostatically chargeable polymeric sheet by rubbing with a buffing material.

U.S. Pat. No. 5,019,447 describes an electrostatic polypropylene base film, which can be laminated with a plurality of various layers including an acrylic coating and a PVdC coating. There is no teaching that this film can adhere to a surface for a long period of time and that it can be used with a support to display written or advertising material.

U.S. Pat. No. 5,258,214 merely describes a wall covering made with the film described in U.S. Pat. No. 5,019,447 and having a preprinted image thereon.

It will be noted that there is a need for a combination of materials wherein the product made therefrom retain its charge for a much longer period of time than to which one is accustomed, such as a plurality of weeks, and enables to display written or design information.

### SUMMARY OF INVENTION

It is an object of the present invention to provide a system wherein an electrostatic product retains its charge much longer than usual.

It is another object of the present invention to provide a pad which is capable of electrostatically adhering against a surface and which is easy to handle even by small children.

It is another object of the present invention to provide a pad that is capable of adhering against a polished surface while retaining electrostatic charges between a core support layer and an electrostatic layer.

It is another object of the present invention to provide a support for an electrostatic layer which enable the electrostatic layer to retain its electrostatic charges without have to rub the electrostatic layer with a buffing material.

These and other objects of the present invention may be achieved by providing a pad which is capable of adhering against a surface after having been activated, which comprises a core support layer made of a foam plastic material, an electrostatic layer on one face of the pad, the opposite face of the pad being capable of receiving information to be displayed. The foam plastic material is characterized by having a closed cell structure and a density between about 1.5 and 4, and by being capable of retaining electrostatic charges between the core support layer and the electrostatic layer after being activated.

Preferably, the core support layer has a thickness up to about 6 mm, more preferably between about 1.5 and 3 mm, and the electrostatic layer has a thickness up to about 100μ, ideally between about 40 and 65μ.

The information which can be provided on the core support layer is preferably in the form of an information layer which comprises the required information, the information layer being laminated on the opposite face of core support layer.

Although many materials may have the property of retaining the electrostatic charges between the core support layer and the electrostatic layer, a preferred material for the core support layer is a copolymer of ethylene and vinyl acetate, known in the trade.

The preferred material for the electrostatic layer is a film of a polypropylene base which can be electrostatically activated known under the trademark Oppalyte®. Of course an electrostatic vinyl and other suitable materials may also be used as long as they retain their charges when in contact a core support layer according to the invention.

### BRIEF DESCRIPTION OF DRAWINGS

The invention will now be illustrated in the annexed drawings by means of one specific embodiment, which is given without limitation, and in which:

FIG. 1 is a perspective view of an electrostatic pad according to the invention;

FIG. 2 is a cross-section view of the pad illustrated in FIG. 1;

FIG. 3 is a view showing a plurality of pads being activated on a surface; and

FIG. 4 is a view showing pieces being arranged on a surface according to a predetermined design.

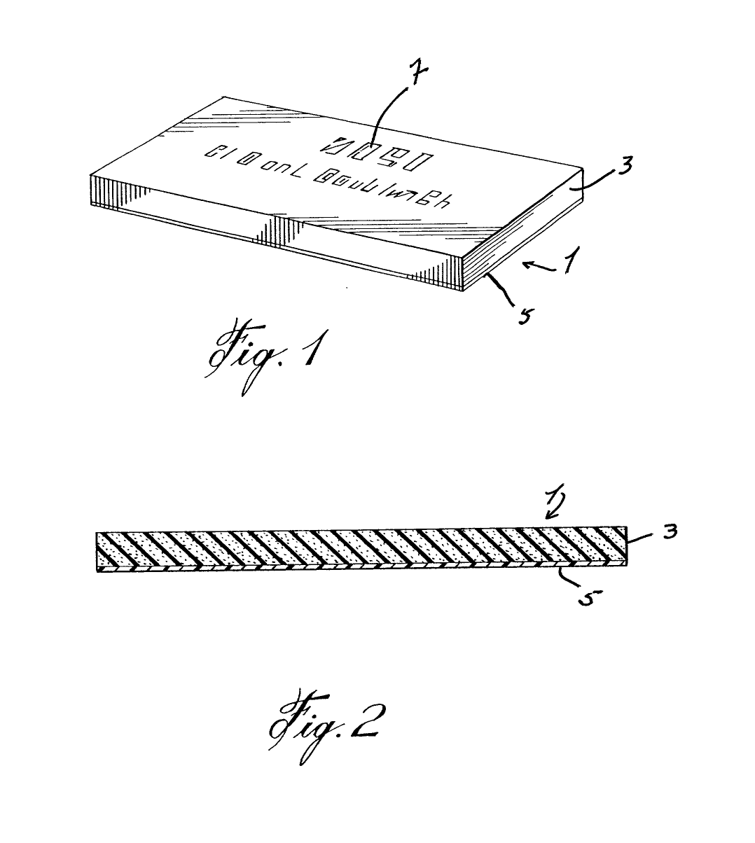

### DESCRIPTION OF PREFERRED EMBODIMENT

With reference to the drawings, it will be seen that pad 1 which is illustrated essentially consists of a core support layer 3 which is a foam material of closed cell structure made of a copolymer of ethylene and vinyl acetate. The copolymer will hereinafter be designated by the abbreviation EVA and is well known to those skilled in the art. The second component of pad 1 is an electrostatic film 5, which is made of a polypropylene which can be electrostatically activated. Suitable materials to be used in producing a pad 1 according to the invention include polypropylene films sold under the trademarks Oppalyte®, Bicor® and the like.

As shown, film 5 is laminated on one face of core support layer 3 by any means known to those skilled in the art. Film 5 which is laminated on core support layer 3 enables the pad to be easily activated and handled. Furthermore, in order to produce a commercially attractive product and achieve the desired properties of adhering to a polished surface for an extended period of time resulting from the fact that the electrostatic film retain its charges for longer than expected, it is essential that the foam material of core support layer be of closed cell structure and have a density between about 1.5 and 4. In the illustrated embodiment, the foam material has a density of about 2.0. Furthermore, core support layer preferably has a thickness between about 1.5 and 3.0 mm. In the illustrated embodiment, the foam material is 3.0 mm thick.

The opposite face of core support layer 3 which is the front face of pad 1 has some information 7 provided thereon. This information may be written material or any suitable design such as a drawing, a picture or part thereof which are intended to be shown using the pad according to the invention. This information may be written on or printed on the front face of pad 1 by any means known to those skilled in the art. This information may also be provided on a sheet of material, such as a sheet of paper or a fabric, which is later on laminated on the front face of pad 1.

Contrary to a known electrostatic object that needs to be electrostatically activated such as by rubbing with a buffer material after a very short period of use, the pad according to the invention retains its charge for a much longer period, to the point that for a normal use it is not necessary to reactivate the electrostatic film. For example, a pad according to the invention, after having been activated, was placed on a polished wall and after one year and a half it has not yet moved, while an electrostatic vinyl sheet often falls away after a few days only.

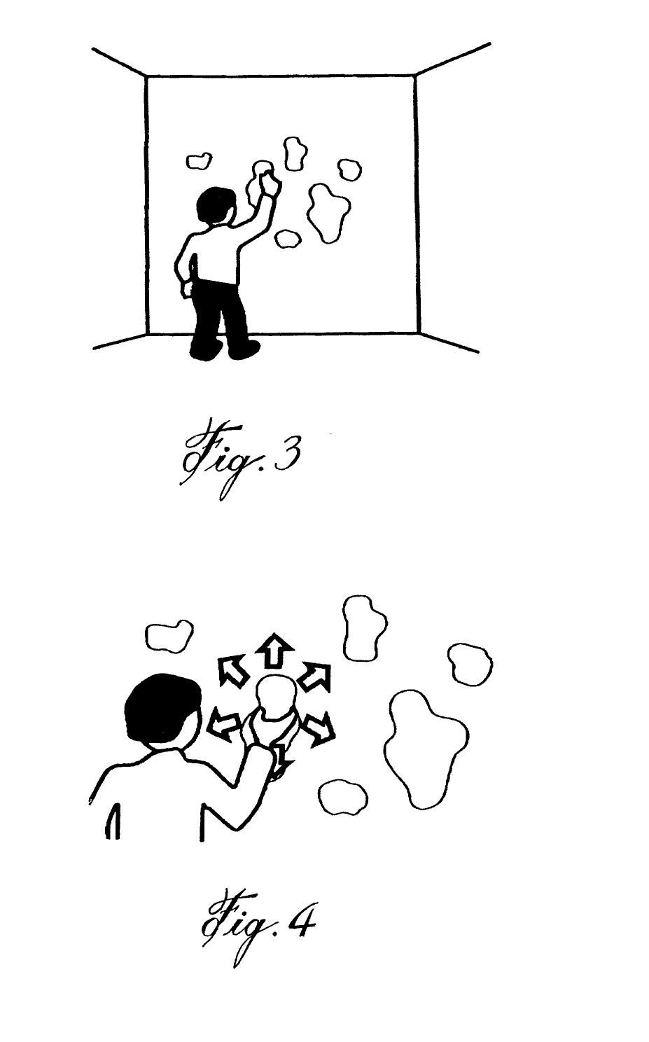

As shown in FIG. 3, the components of a system comprising a variety of pads, are activated by rubbing against a surface and are immediately placed thereon. Activation consists in grabbing each piece by the sides and rubbing the surface containing the electrostatic layer on a surface for 5 to 10 seconds. To be sure that a maximum charge is imparted, it is important to contact the entire electrostatic layer against the surface.

Once the pieces are on place on the surface, they can be moved to produce the desired result. If they are not lifted from the surface, they should remain in place practically indefinitely. If one of the pieces looses its electrostatic charge, it merely has to be reactivated for 5 to 10 seconds.

Although the invention has been described with reference to a specific embodiment, it is not limited thereto except as defined in the appended claims.

1. A pad capable of adhering against a surface after having been activated thereon, comprising a core support layer made of a foam plastic material, an electrostatic layer on one face of said pad, an opposite face of said pad being capable of receiving thereon information to be displayed, said foam plastic material being characterized by having a closed cell structure and a density between 1.5 and 4, and by being capable of retaining electrostatic charges between said core support layer and said electrostatic layer after being activated.

2. Pad according to claim 1, wherein said core support layer has a thickness up to about 6 mm and said electrostatic layer has a thickness up to about 100 μp.

3. Pad according to claim 2, wherein said core support layer has a thickness between about 1.5 and 3 mm and said electrostatic layer has a thickness between about 40 and 65μ.

4. Pad according to claim 1, wherein said information comprise an information layer comprising a representation, said information layer being laminated on said opposite face.

5. Pad according to claim 1, wherein said core support layer is made of a copolymer of ethylene and vinyl acetate.

6. Pad according to claim 5, wherein said electrostatic layer comprises a film of a polypropylene base which can be electrostatically activated.

7. A pad capable of adhering against a polished surface, comprising a core support layer made of a foam copolymer of ethylene and vinyl acetate, said foam copolymer having a closed cell structure and a density between 1.5 and 2, and a thickness between 1.5 and 3 mm, a layer of electrostatic polypropylene base having a thickness between about 40 and 65μ laminated on one face of said core support layer, an opposite face of said core support layer being constructed to receive information thereon, said core support layer being characterized by being capable of retaining electrostatic charges between said core support layer and said layer of electrostatic polypropylene.
